(19) United States
(12) Patent Application Publication
(10) Pub. No.: US 2010/0214015 A1
(43) Pub. Date: Aug. 26, 2010

(54) DETECTION CIRCUIT AND PHYSICAL QUANTITY SENSOR DEVICE

(76) Inventors: Yoshitsugu Takasawa, Osaka (JP); Motonori Taniguchi, Kyoto (JP); Yoichi Kaino, Osaka (JP)

Correspondence Address: MCDERMOTT WILL & EMERY LLP, 600 13TH STREET, NW, WASHINGTON, DC, 20005-3096, US

(21) Appl. No.: 12/609,766

(22) Filed: Oct. 30, 2009

(30) Foreign Application Priority Data
Feb. 24, 2009 (JP) 2009-040837

(51) Int. Cl. G06G 7/12

(52) U.S. Cl. 327/563

(57) ABSTRACT

A switched capacitor has a differential amplifier and a sampling capacitance and a feedback capacitance at least one of which has a variable capacitance value, and is switchable between a first drive mode of amplifying an input signal with a positive gain responsive to the capacitance ratio of the sampling capacitance to the feedback capacitance and a second drive mode of amplifying the input signal with a negative gain responsive to the capacitance ratio. A control circuit changes the capacitance ratio, and also changes the drive mode of the switched capacitor, at predetermined timing.

### CROSS-REFERENCE TO RELATED APPLICATIONS

This application claims priority under 35 U.S.C. §119 on Patent Application No. 2009-40837 filed in Japan on Feb. 24, 2009, the entire contents of which are hereby incorporated by reference.

### BACKGROUND OF THE INVENTION

The technique disclosed herein relates to a detection circuit that detects a desired signal from an input signal.

Conventionally, in a variety of signal processing systems such as reception systems and sensor systems, detection circuits that perform synchronous detection of a desired signal from an input signal (a reception signal, a sensor signal, etc.) have been used. As one type of such detection circuits, a synchronous detection circuit that executes full-wave rectification processing and smoothing processing using a switched capacitor is known (see Japanese Laid-Open Patent Publication No. 2005-20434, for example). In a detection circuit disclosed in Japanese Laid-Open Patent Publication No. 2005-20434, the supply state of two-phase clocks is changed with the transition of a rectangular wave signal, to thereby allow a single switched capacitor to function as a normal-phase integrator and a reverse-phase integrator selectively. With this switching between the two functions of the switched capacitor, the input signal is virtually multiplied by the rectangular wave signal, and the multiplication result is outputted as a detection output signal.

### SUMMARY OF THE INVENTION

However, in the conventional detection circuit, in which the gain of the switched capacitor is a fixed value, it is not possible to approximate the time change in the gain of the switched capacitor to a waveform other than the rectangular wave (e.g., a trigonometric function wave). In the multiplication of the input signal by the rectangular wave signal, a number of harmonic components included in the rectangular wave signal will be wrapped in a DC component of the detection output signal, and hence a large amount of noise will be superimposed on the DC component of the detection output signal. In the conventional detection circuit, therefore, it is difficult to improve the detection precision.

An object of the technique disclosed herein is to provide a detection circuit in which the time change in the gain of a switched capacitor can be approximated to a desired waveform.

According to one aspect of the present invention, the detection circuit is a detection circuit configured to detect a desired signal from an input signal, including: a switched capacitor having a differential amplifier and a sampling capacitance and a feedback capacitance at least one of which has a variable capacitance value, the switched capacitor being switchable between a first drive mode of amplifying the input signal with a positive gain responsive to a capacitance ratio of the sampling capacitance to the feedback capacitance and a second drive mode of amplifying the input signal with a negative gain responsive to the capacitance ratio; and a control circuit configured to change the capacitance ratio, and also change the drive mode of the switched capacitor, at predetermined timing. In the detection circuit described above, which changes the capacitance ratio of the sampling capacitance to the feedback capacitance and also changes the drive mode of the switched capacitor, the value and sign (plus or minus) of the gain of the switched capacitor can be changed arbitrarily. Hence, the time change in the gain of the switched capacitor can be approximated to a desired waveform. For example, the time change in the gain of the switched capacitor can be approximated to the waveform of a detection signal for detecting the desired signal (e.g., the waveform of a trigonometric function wave signal synchronizing with the input signal). With this control, noise superimposed on the detection output signal (output of the switched capacitor) can be reduced, and thus the detection precision can be improved.

Preferably, at least one of the sampling capacitance and the feedback capacitance includes: n (n is an integer equal to or more than 2) capacitances each being switchable between a valid state where the capacitance is used as the sampling capacitance or the feedback capacitance and an invalid state where the capacitance is not used as the sampling capacitance or the feedback capacitance, the n capacitances having capacitance values different from each other; and a capacitance setting section configured to set one capacitance or a plurality of capacitances, among the n capacitances, to the valid state so that the total of the capacitance value or values of the capacitance or capacitances in the valid state, among the n capacitances, should be a value corresponding to the control by the control circuit. With this configuration, area increase can be suppressed compared with the case of setting the n capacitances to the valid state individually.

### BRIEF DESCRIPTION OF THE DRAWINGS

FIG. 1 is a view showing an example configuration of a detection circuit of Embodiment 1.

FIG. 2 is a view illustrating an example of the operation of the detection circuit of FIG. 1.

FIG. 3 is a view illustrating a time change in the gain of a switched capacitor in the operation shown in FIG. 2.

FIG. 4 is a view illustrating a time change in the gain of the switched capacitor in another example of the operation of the detection circuit of FIG. 1.

FIG. 5 is a view illustrating a time change in the gain of the switched capacitor in yet another example of the operation of the detection circuit of FIG. 1.

FIG. 6 is a view illustrating the operation of the detection circuit for implementing the time change in the gain of the switched capacitor shown in FIG. 5.

FIG. 7 is a view showing an example configuration of a sampling capacitance shown in FIG. 1.

FIG. 8 is a view illustrating an example of the operation of the sampling capacitance of FIG. 7.

FIG. 9 is a view illustrating another example of the operation of the sampling capacitance of FIG. 7.

FIG. 10 is a view showing an example configuration of a physical quantity sensor device of Embodiment 2.

FIG. 11 is a view illustrating the detection operation of the physical quantity sensor device of FIG. 10.

### DESCRIPTION OF THE PREFERRED EMBODIMENTS

Hereinafter, preferred embodiments of the present invention will be described in detail with reference to the accompanying drawings. It should be noted that identical or equivalent components are denoted by the same reference characters throughout the drawings, and description thereof will not be repeated.

### Embodiment 1

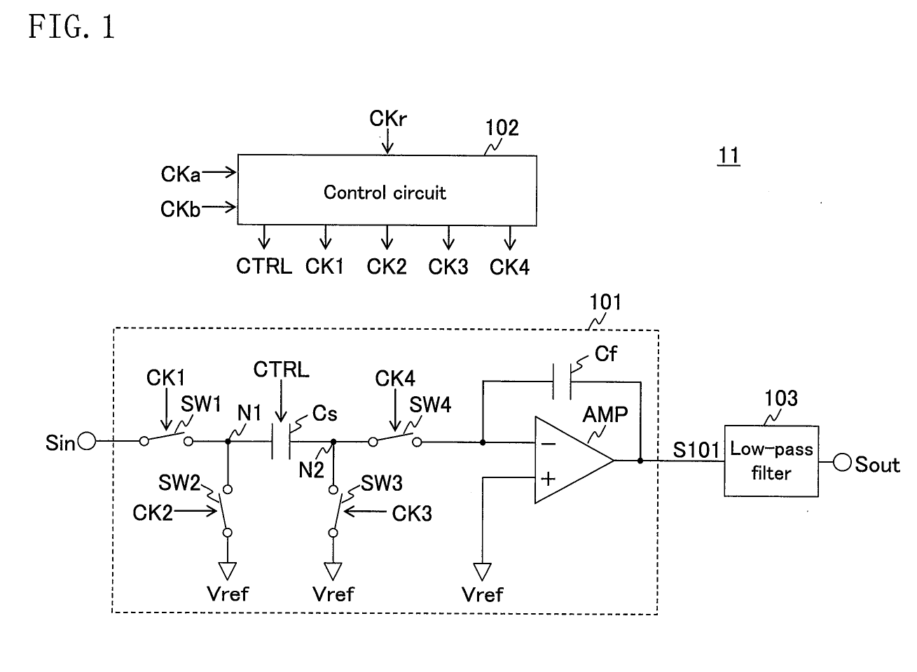

FIG. 1 shows an example configuration of a detection circuit of Embodiment 1. The detection circuit 11, which detects a desired signal (signal superimposed on an input signal Sin) from the input signal Sin, includes a switched capacitor 101, a control circuit 102, and a low-pass filter 103.

The switched capacitor 101 includes a differential amplifier AMP, a sampling capacitance Cs, a feedback capacitance Cf, and switches SW1, SW2, . . . , SW4. The switches SW1, SW2, . . . , SW4 are turned ON/OFF in response to respective control clocks CK1, CK2, . . . , CK4. In the illustrated example, the sampling capacitance Cs is a variable capacitance whose capacitance value can be set with a control signal CTRL. Also, the switched capacitor 101 has a crawl-type drive mode and a butterfly-type drive mode, and amplifies the input signal Sin with a gain responsive to the capacitance ratio of the sampling capacitance Cs to the feedback capacitance Cf (Cs/Cf) and outputs the amplified signal as a detection output signal S101. When the switched capacitor 101 is in the crawl-type drive mode, the state where the switches SW1 and SW3 are ON and the state where the switches SW2 and SW4 are ON appear alternately. In this case, the gain of the switched capacitor 101 is a positive gain responsive to the capacitance ratio (Cs/Cf). On the contrary, when the switched capacitor 101 is in the butterfly-type drive mode, the state where the switches SW1 and SW4 are ON and the state where the switches SW2 and SW3 are ON appear alternately. In this case, the gain of the switched capacitor 101 is a negative gain responsive to the capacitance ratio (Cs/Cf). The reference voltage Vref may be a ground voltage value (0 V) or another voltage value.

The control circuit 102 changes the capacitance ratio of the sampling capacitance Cs to the feedback capacitance Cf (Cs/Cf) at predetermined timing using the transition timing (rising edges in the illustrated example) of a reference clock CKr synchronizing with the input signal Sin as the reference. For example, the control circuit 102 outputs the control signal CTRL for controlling the capacitance value of the sampling capacitance Cs, to change the capacitance value of the sampling capacitance Cs in synchronization with a multiplied clock CKa (clock having a frequency higher than that of the reference clock CKr). Also, the control circuit 102 changes the drive mode of the switched capacitor 101 using the transition timing of the reference clock CKr as the reference. For example, the control circuit 102 switches the clock supply state between a first supply state of supplying the multiplied clock CKa as the control clocks CK1 and CK3 while supplying a multiplied clock CKb (clock changing complementarily to the multiplied clock CKa) as the control clocks CK2 and CK4 and a second supply state of supplying the multiplied clock CKa as the control clocks CK1 and CK4 while supplying the multiplied clock CKb as the control clocks CK2 and CK3. The operation mode of the switched capacitor 101 is set at the crawl-type drive mode when the clocks are in the first supply state, and set at the butterfly-type drive mode when they are in the second supply state.

The low-pass filter 103 attenuates noise included in the detection output signal S101 and outputs the resultant signal as a detection signal Sout. The detection circuit 11 does not have to include the low-pass filter 103.

[Operation]

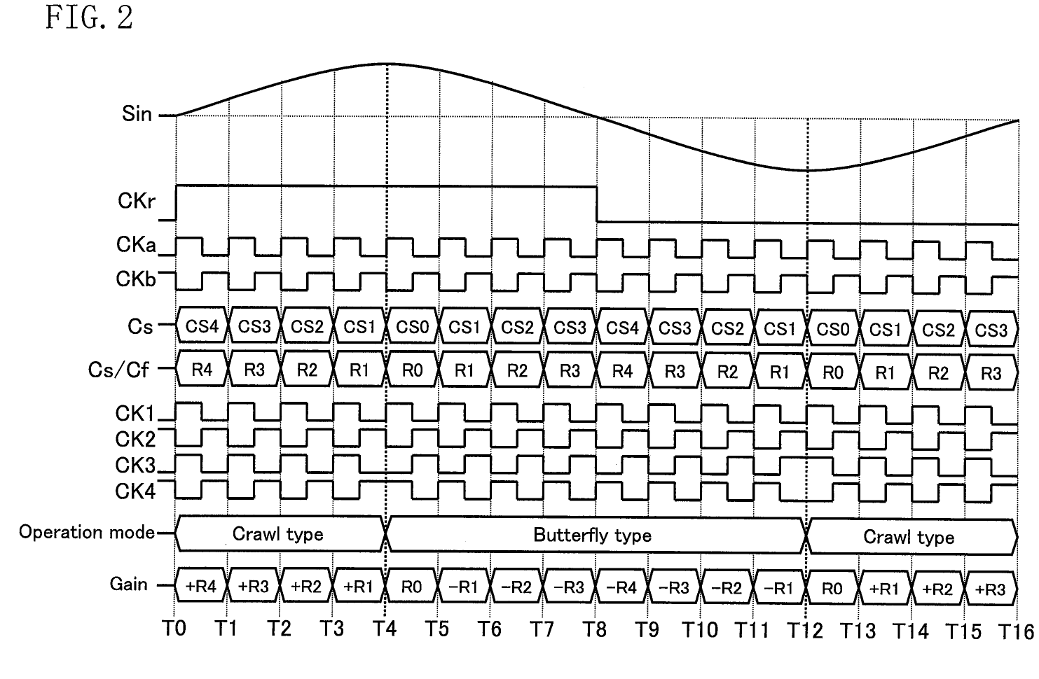

Next, the operation of the detection circuit 11 of FIG. 1 will be described with reference to FIG. 2. Assume here that the frequency of the multiplied clocks CKa and CKb is sixteen times as high as that of the reference clock CKr. Assume also that the capacitance value of the sampling capacitance Cs can be set in five stages (capacitance values CS0, CS1, CS2, CS3, and CS4), where CS0=0.000, CS1=0.383×Cf, CS2=0.707×Cf, CS3=0.924×Cf, and CS4=1.000×Cf. That is, if the capacitance value of the sampling capacitance Cs is “CS0”, nodes N1 and N2 will be short-circuited to each other.

The control circuit 102 sets the capacitance value of the sampling capacitance Cs at the capacitance value CS4 in response to the transition timing of the reference clock CKr, and then changes the capacitance value of the sampling capacitance Cs by one stage at a time in synchronization with the multiplied clock CKa. To state specifically, during the time period of time T0 to T4 and the time period of time T8 to T12, the control circuit 102 decreases the capacitance value of the sampling capacitance Cs by one stage at a time from CS4 to CS3, . . . , CS0 in this order. With this, the capacitance ratio (Cs/Cf) decreases by one stage at a time from R4 to R3, . . . , R0 in this order. On the contrary, during the time period of time T4 to T8 and the time period of time T12 to T16, the control circuit 102 increases the capacitance value of the sampling capacitance Cs by one stage at a time from CS0 to CS1, CS4 in this order. With this, the capacitance ratio (Cs/Cf) increases by one stage at a time from R0 to R1, . . . , R4 in this order. Note that the capacitance ratios R0, R1, . . . , R4 are respectively 0.000, 0.383, 0.707, 0.924, and 1.000.

Also, the control circuit 102 sets the supply state of the multiplied clocks CKa and CKb at the first supply state in response to the transition timing of the reference clock CKr. Specifically, the multiplied clock CKa is supplied as the control clocks CK1 and CK3, and the multiplied clock CKb is supplied as the control clocks CK2 and CK4. Once a quarter of the period of the reference clock CKr has passed from the transition timing of the reference clock CKr (at time T4), the control circuit 102 switches the supply state of the multiplied clocks CKa and CKb from the first supply state to the second supply state. Specifically, the multiplied clock CKa is supplied as the control clocks CK1 and CK4, and the multiplied clock CKb is supplied as the control clocks CK2 and CK3. Thereafter, once three quarters of the period of the reference clock CKr has passed from the transition timing of the reference clock CKr (at time T12), the control circuit 102 switches the supply state of the multiplied clocks CKa and CKb from the second supply state to the first supply state. In this way, with the change of the supply state of the multiplied clocks CKa and CKb, the drive mode of the switched capacitor 101 is set at the crawl-type drive mode during the time period of time T0 to T4 and the time period of time T12 to T16, and set at the butterfly-type drive mode during the time period of time T4 to T12.

During the time period of time T0 to T4 and the time period of time T13 to T16, in which the switched capacitor 101 is in the crawl-type drive mode, the gain of the switched capacitor 101 is a positive gain value (+R4, +R3, . . . , +R1) responsive to the capacitance ratio (Cs/Cf). On the contrary, during the time period of time T5 to T12, in which the switched capacitor 101 is in the butterfly-type drive mode, the gain of the switched capacitor 101 is a negative gain value (−R1, −R2, . . . , −R4) responsive to the capacitance ratio (Cs/Cf). Note that during the time period of time T4 to T5 and the time period of time T12 to T13, the gain of the switched capacitor 101 is the gain value R0.

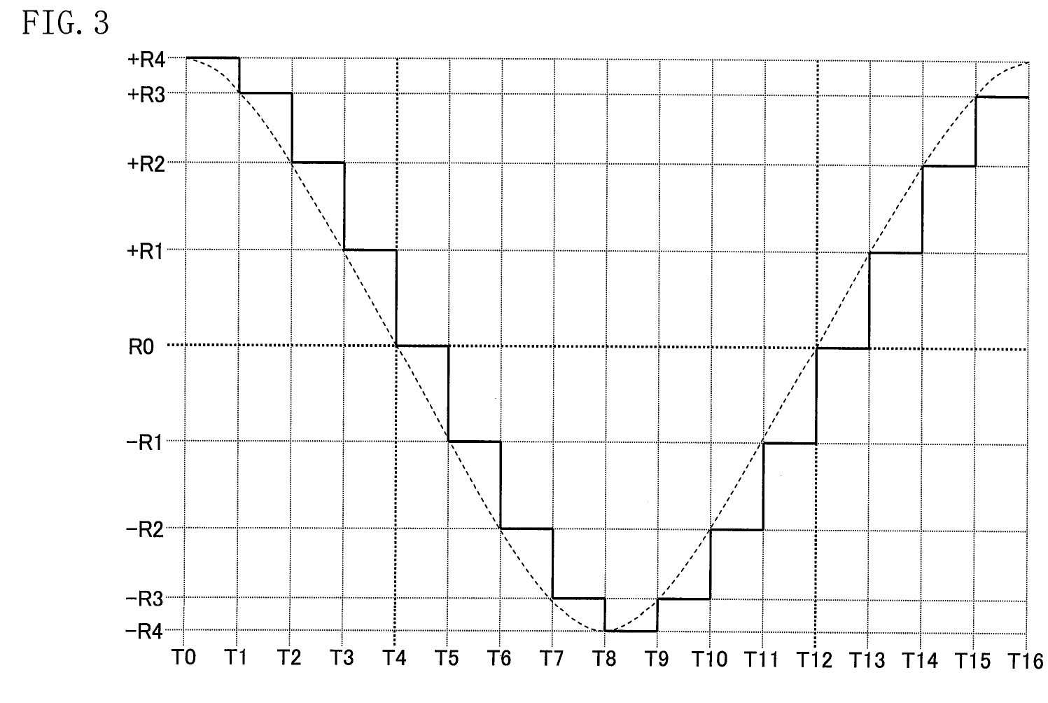

Hence, by changing the capacitance ratio (Cs/Cf) in five stages and also changing the operation mode of the switched capacitor 101, the gain of the switched capacitor 101 can be changed in nine stages. Also, as shown in FIG. 3, the time change in the gain of the switched capacitor 101 can be approximated to a trigonometric function waveform (in the illustrated example, the waveform of a cosine wave signal having the same frequency as the reference clock CKr). In other words, the gain values (+R4), (+R3), . . . , (−R4) respectively correspond to cosine values (values of the cosine wave signal) at time T0, T1, . . . , T8 (time T16, T15, . . . , T8).

With the gain of the switched capacitor 101 being changed as shown in FIG. 3, the input signal Sin is virtually multiplied by the cosine wave signal (detection signal expressed by the time change in the gain of the switched capacitor 101). Assuming here that the input signal Sin is “2 sin(ωt)” and the cosine wave signal (the time change in the gain of the switched capacitor 101) is “cos(ωt)”, the detection output signal S101 can be expressed as:

$$\begin{matrix}S 101 = \int 2 sin ( ω t ) cos ( ω t ) d t \\ = {sin}^{2 ( ω t )} \\ = \frac{1}{2} - cos ( 2 ω t ) / 2\end{matrix}$$

As is found from the above expression, the detection output signal S101 can be expressed by a DC component “½” and a frequency component having a frequency twice as high as that of the input signal Sin (double wave component) “cos(2ωt)/2.” In this way, unlike a rectangular wave signal, the trigonometric function wave signal (cosine wave signal in the illustrated example) does not include a harmonic component. Hence, noise superimposed on the detection output signal S101 can be reduced, compared with the case of multiplying the input signal Sin by a rectangular wave signal. The low-pass filter 103 attenuates the double wave component of the detection output signal S101 and outputs the resultant signal as the detection signal Sout.

As described above, by changing the capacitance ratio of the sampling capacitance Cs to the feedback capacitance Cf (Cs/Cf) and also changing the drive mode of the switched capacitor 101, the value and sign (plus or minus) of the gain of the switched capacitor 101 can be changed arbitrarily. This makes it possible to approximate the time change in the gain of the switched capacitor 101 to the waveform of a desired detection signal (e.g., the waveform of a trigonometric function wave signal synchronizing with the input signal). Hence, noise superimposed on the detection output signal S101 can be reduced, and thus the detection precision can be improved. Note that the waveform of the detection signal (the time change in the gain of the switched capacitor 101) may be a trigonometric function waveform such as a cosine waveform and a sine waveform, or may be a triangular waveform, a sawtooth waveform, or another signal waveform.

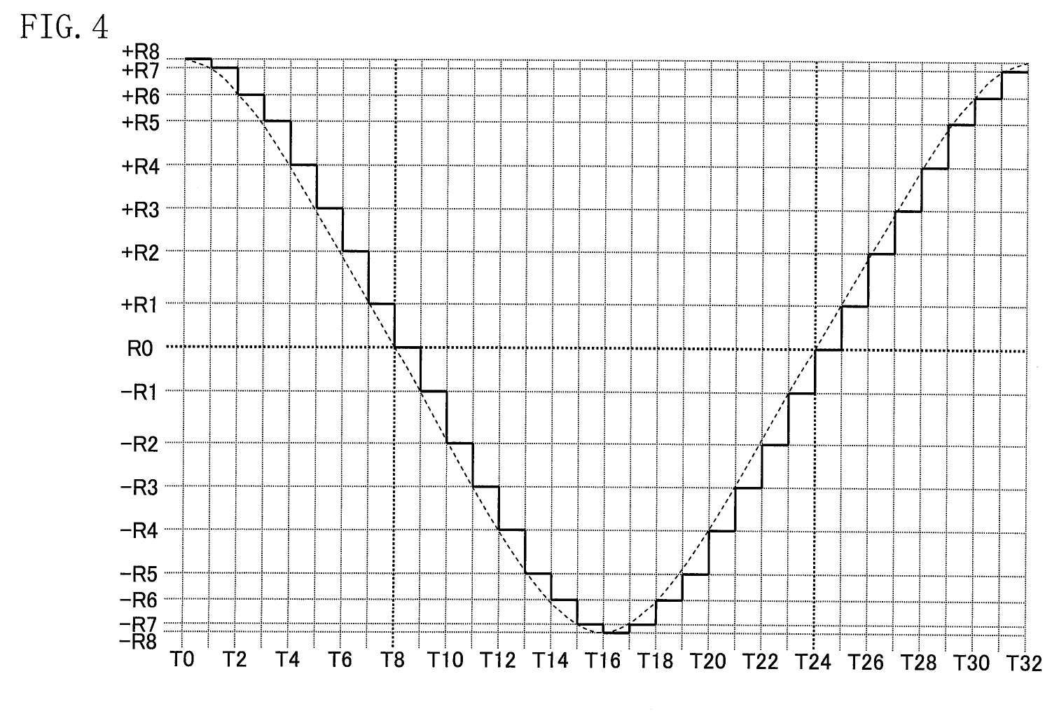

The number of stages of the variable gain value of the switched capacitor 101 is not limited to nine. For example, as shown in FIG. 4, seventeen stages may be given to the variable gain value of the switched capacitor 101. In this example of operation, the capacitance ratio (Cs/Cf) can be set in nine stages (capacitance ratios R0, R1, . . . , R8), where R0=0.000, R1=0.195, R2=0.383, R3=0.556, R4=0.707, R5=0.831, R6=0.924, R7=0.981, and R8=1.000. In this case, also, the frequency of the multiplied clocks CKa and CKb is thirty-two times as high as that of the reference clock CKr. The control circuit 102 changes the capacitance value of the capacitance Cs at time T0, T1, . . . , T32, and also changes the supply state of the multiplied clocks CKa and CKb once a quarter of the period of the reference clock CKr has passed from the transition timing of the reference clock CKr (at time T8) and once three quarters of the period of the reference clock CKr has passed (at time T24).

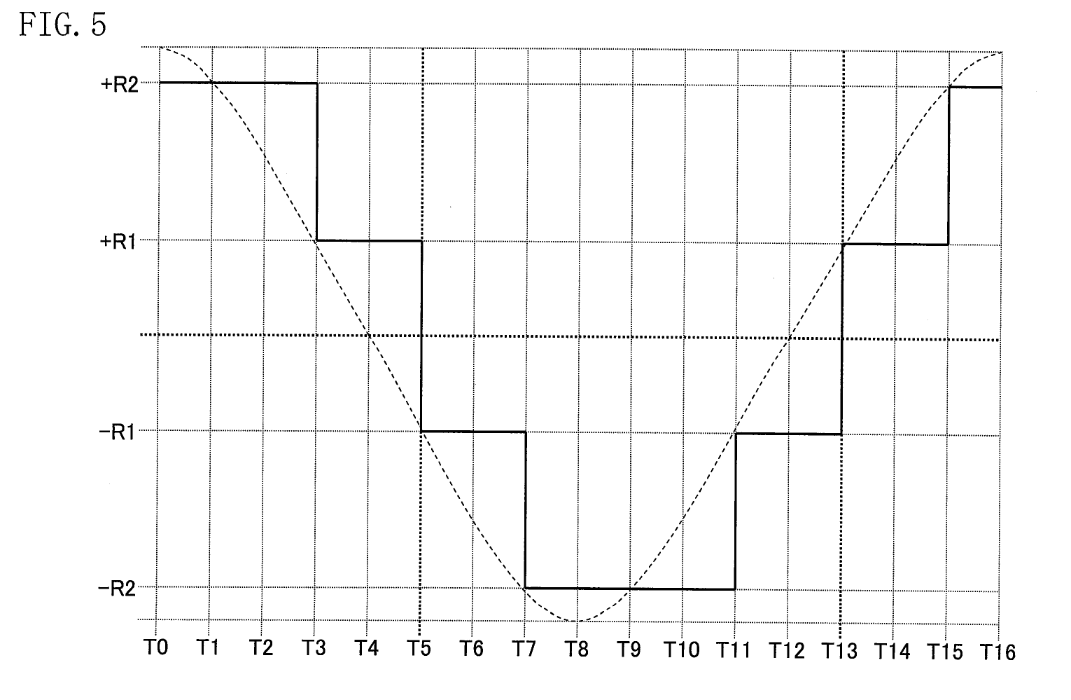

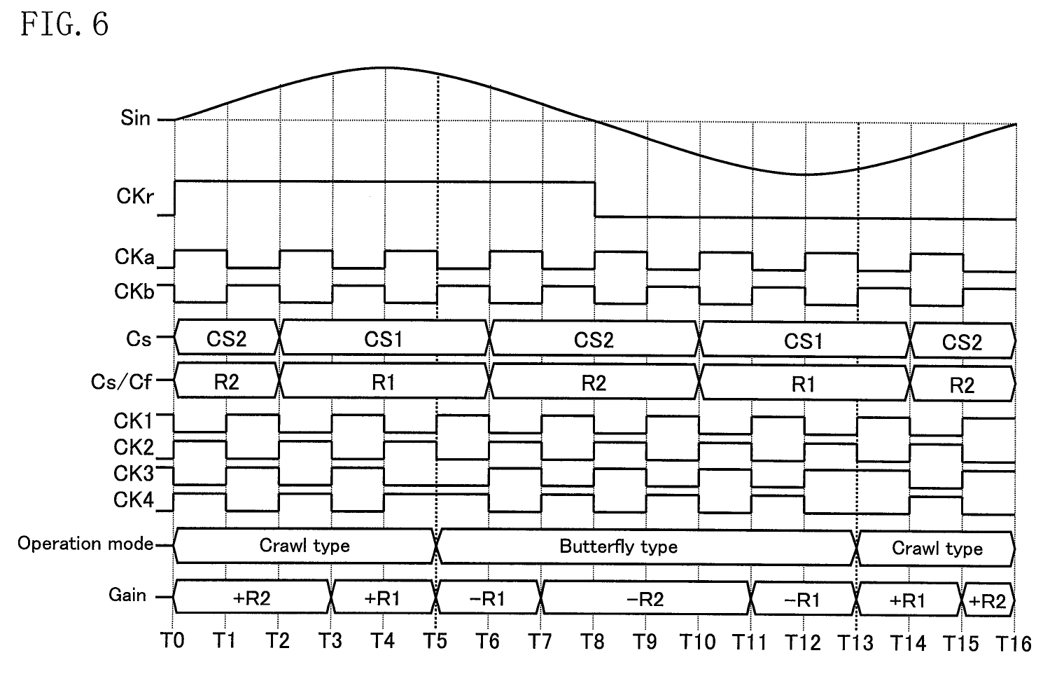

Alternatively, as shown in FIG. 5, four stages may be given to the variable gain value of the switched capacitor 101. In this example of operation, the capacitance ratio (Cs/Cf) can be set in two stages (capacitance ratios R1 and R2), where R1=0.383 and R2=0.924. The gain values (+R2, +R1, −R1 and −R2) respectively correspond to the cosine values at time T1, T3, T5, and T7 (time T15, T13, T11 and T9). Also, as shown in FIG. 6, the frequency of the multiplied clocks CKa and CKb is eight times as high as that of the reference clock CKr. The capacitance value of the sampling capacitance Cs can be set in two stages (capacitance values CS1 and CS2), where CS1=0.383×Cf and CS2=0.924×Cf. In this example of operation, the control circuit 102 changes the capacitance value of the capacitance Cs at time T2, T6, T10, and T14, and also changes the supply state of the multiplied clocks CKa and CKb at time T5 and T13. Specifically, during the time period of time T0 to T5 and the time period of time T13 to T16, the multiplied clock CKa is supplied as the control clocks CK2 and CK4, and the multiplied clock CKb is supplied as the control clocks CK1 and CK3. During the time period of time T5 to T13, the multiplied clock CKa is supplied as the control clocks CK2 and CK3, and the multiplied clock CKb is supplied as the control clocks CK1 and CK4.

The control circuit 102 may start counting of pulses of a multiplied clock (clock having a frequency higher than that of the reference clock CKr) in response to the transition timing of the reference clock CKr, and execute changing of the capacitance ratio (Cs/Cf) and changing of the clock supply state based on the count value. The frequency of the multiplied clock for defining the timing of change of the capacitance ratio (Cs/Cf) is preferably at least four times as high as that of the input signal Sin.

[Sampling Capacitance]

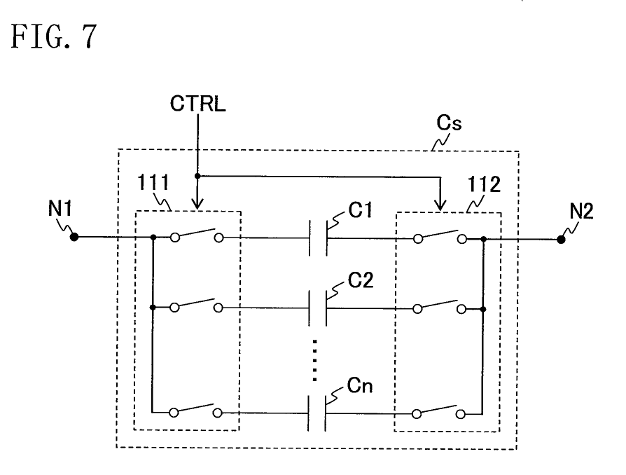

FIG. 7 shows an example configuration of the sampling capacitance Cs shown in FIG. 1. The sampling capacitance Cs includes n (n is an integer equal to or more than 2) capacitances C1, C2, . . . , Cn, and capacitance setting sections 111 and 112. The capacitances C1, C2, . . . , Cn are individually switchable between a valid state where the capacitance is used as the sampling capacitance Cs (state where it is electrically connected between the nodes N1 and N2) and an invalid state where the capacitance is not used as the sampling capacitance Cs (state where it is not electrically connected between the nodes N1 and N2), and have capacitance values different from each other. The capacitance setting sections 111 and 112 set one capacitance or a plurality of capacitances, among the capacitances C1, C2, . . . , Cn, to the valid state so that the total of the capacitance value or values of the capacitance or capacitances in the valid state, among the capacitances C1, C2, . . . , Cn, should be the value corresponding to the control signal CTRL.

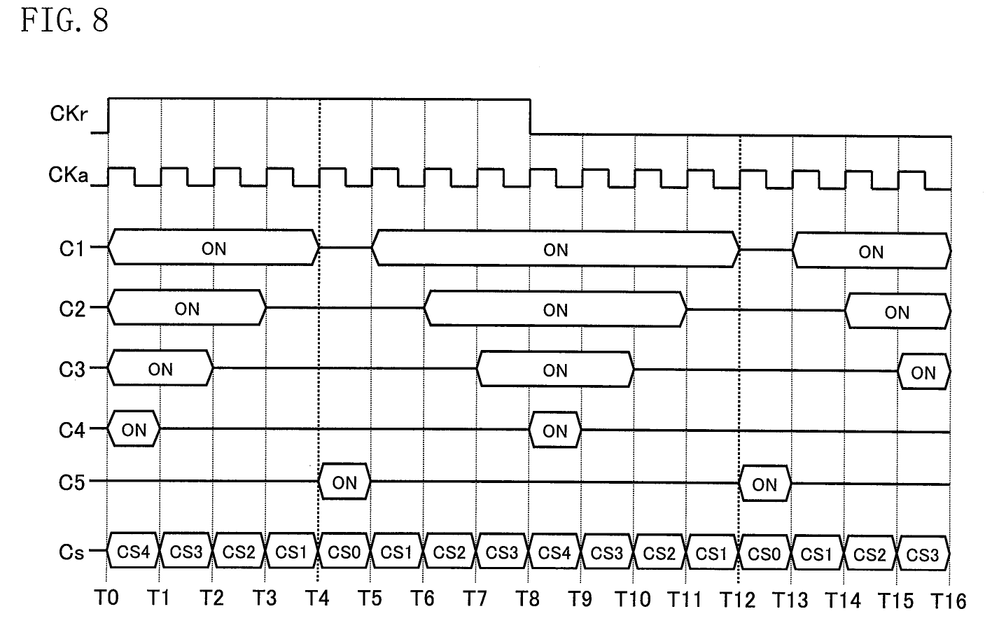

Next, an example of the operation of the sampling capacitance Cs of FIG. 7 will be described with reference to FIG. 8. Assume here that the capacitance value of the sampling capacitance Cs can be set in five stages. Assume also that the number of capacitances is “5”, and the capacitance values of the capacitances C1, C2, . . . , C5 are C1=0.383×Cf, C2=0.324×Cf, C3=0.217×Cf, C4=0.076×Cf, and C5=0.000. The capacitance C5 serves as an interconnect for short-circuiting the nodes N1 and N2 to each other. In other words, this operation corresponds to the operation shown in FIG. 2.

At time T0, the capacitances C1, C2, C3 and C4 are set to the valid state. With this, the capacitance value of the sampling capacitance Cs becomes the total of the capacitance values of the capacitances C1, C2, C3 and C4: namely, it is set at the capacitance value CS4 (=1.000×C0. Thereafter, at time T1, T2, and T3, the capacitances C4, C3, and C2 are set to the invalid state one by one in this order, whereby the capacitance value of the sampling capacitance Cs decreases to the capacitance value CS3 (=0.924×Cf), CS2 (=0.707×Cf), and CS1 (=0.383×C0 in this order. At time T4, while the capacitances C1, C2, . . . , C4 are in the invalid state, the capacitance C5 is set to the valid state. With this, the capacitance value of the sampling capacitance Cs is set at the capacitance value CS0 (=0.000).

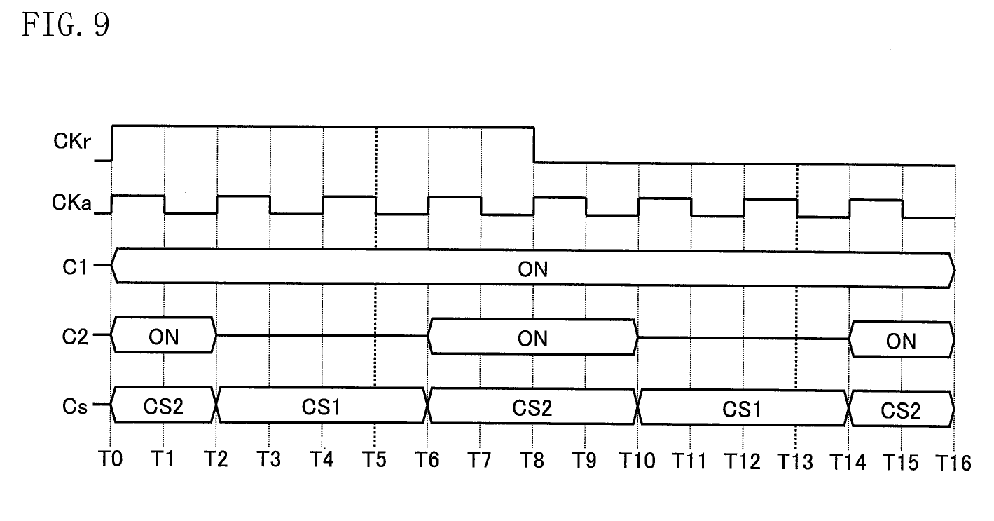

In the case when the capacitance value of the sampling capacitance Cs can be set in two stages, as shown in FIG. 9, the number of capacitances may be “2”, and the capacitance values of the capacitances C1 and C2 may be C1=0.383×Cf and C2=0.541×Cf. That is, this example of operation corresponds to the operation shown in FIG. 6. In this operation, the capacitance C1 is steadily set to the valid state, and the capacitance C2 is set to the valid state at time T0, T6, and T14 and to the invalid state at time T2 and T10. With this, the capacitance value of the sampling capacitance Cs is set at the capacitance value CS2 (=0.924×Cf) during the time period of time T0 to T2, the time period of time T6 to T10, and the time period of time T14 to T16, and set at the capacitance value CS1 (=0.383×Cf) during the remaining time periods.

As described above, by setting the capacitance value of the sampling capacitance Cs in combination of the capacitances C1, C2, . . . , Cn having capacitance values different from each other, the total of the capacitance values of the capacitances C1, C2, . . . , Cn can be reduced compared with the case of setting the capacitances C1, C2, . . . , Cn to the valid state individually, and hence increase in the area of the sampling capacitance Cs can be suppressed.

Not only the sampling capacitance Cs but also the feedback capacitance Cf may be made variable. That is, the capacitance value of at least either the sampling capacitance Cs or the feedback capacitance Cf may be made variable to obtain the switched capacitor 101 having a variable gain value. The feedback capacitance Cf may be configured as shown in FIG. 7.

### Embodiment 2

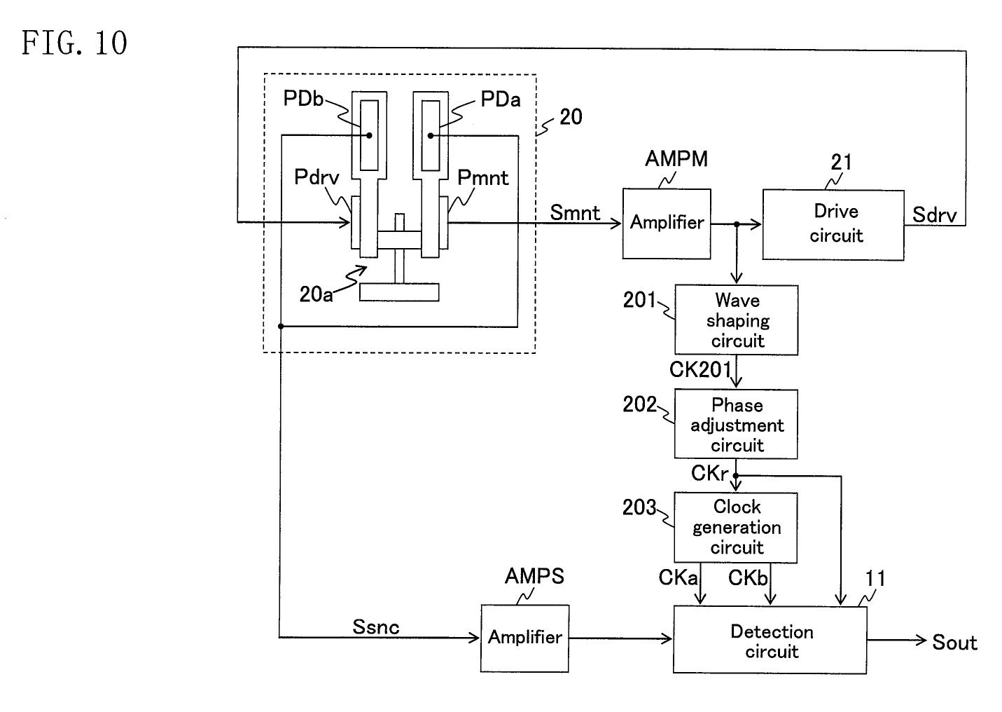

FIG. 10 shows an example configuration of a physical quantity sensor device of Embodiment 2. The physical quantity sensor device includes a physical quantity sensor 20, amplifiers AMPM and AMPS, a drive circuit 21, a wave shaping circuit 201, a phase adjustment circuit 202, a clock generation circuit 203, and the detection circuit 11 of FIG. 1.

The physical quantity sensor 20 vibrates from self-excitation by application of a drive signal Sdrv and outputs a monitor signal Smnt responsive to the self-excited vibration. Also, the physical quantity sensor 20 outputs a sensor signal Ssnc according to a physical quantity (e.g., an angular velocity, an acceleration, etc.) given externally. In the illustrated example, the physical quantity sensor 20 is described as a tuning fork type angular velocity sensor. The physical quantity sensor 20 includes, for example, a tuning fork body 20a, a drive piezoelectric element Pdrv, a monitor piezoelectric element Pmnt, and sensor piezoelectric elements PDa and PDb. The tuning fork body 20a has two prongs each twisted by the right angle in the center, a connection for connecting the two prongs at their ends on one side, and a support pin provided at the connection to serve as a rotation axis. The drive piezoelectric element Pdrv vibrates one prong according to the drive signal Sdrv, and this causes resonance of the two prongs. With this vibration of the tuning fork, charge is generated in the monitor piezoelectric element Pmnt (i.e., the monitor signal Smnt is generated). Also, when a rotational angular velocity (Coriolis force) is generated, an amount of charge responsive to the rotational angular velocity is generated in the sensor piezoelectric elements PDa and PDb (i.e., the sensor signal Ssnc is generated). The sensor signal Ssnc includes a physical quantity signal corresponding to the physical quantity given to the physical quantity sensor 20 superimposed thereon. In other words, the sensor signal Ssnc (several tens of kHz, for example) has been amplitude-modulated with the physical quantity signal (several Hz, for example). The physical quantity sensor 20 does not have to be of the tuning fork type, but may be of a circular cylinder type, a regular triangular prism type, a square prism type, or a ring type, or may be of another shape.

The amplifier AMPM amplifies the monitor signal Smnt from the physical quantity sensor 20. The drive circuit 21 controls the drive signal Sdrv according to the amplitude of the monitor signal Smnt so that the amplitude of the monitor signal Smnt supplied via the amplifier AMPM should be kept constant. With this control, the speed of the vibration of the physical quantity sensor 20 can be kept constant. The wave shaping circuit 201 converts the monitor signal Smnt supplied via the amplifier AMPM to a square wave and outputs the resultant signal as a reference clock CK201. The phase adjustment circuit 202 adjusts the phase of the reference clock CK201 so that the phase of the reference clock CKr should match with the phase of the sensor signal Ssnc, and outputs the resultant signal as the reference clock CKr. The clock generation circuit 203 multiplies the reference clock CKr to generate the multiplied clocks CKa and CKb. The amplifier AMPS amplifies the sensor signal Ssnc from the physical quantity sensor 20. The detection circuit 11, receiving the reference clock CKr and the multiplied clocks CKa and CKb, detects the physical quantity signal from the sensor signal Ssnc supplied via the amplifier AMPS.

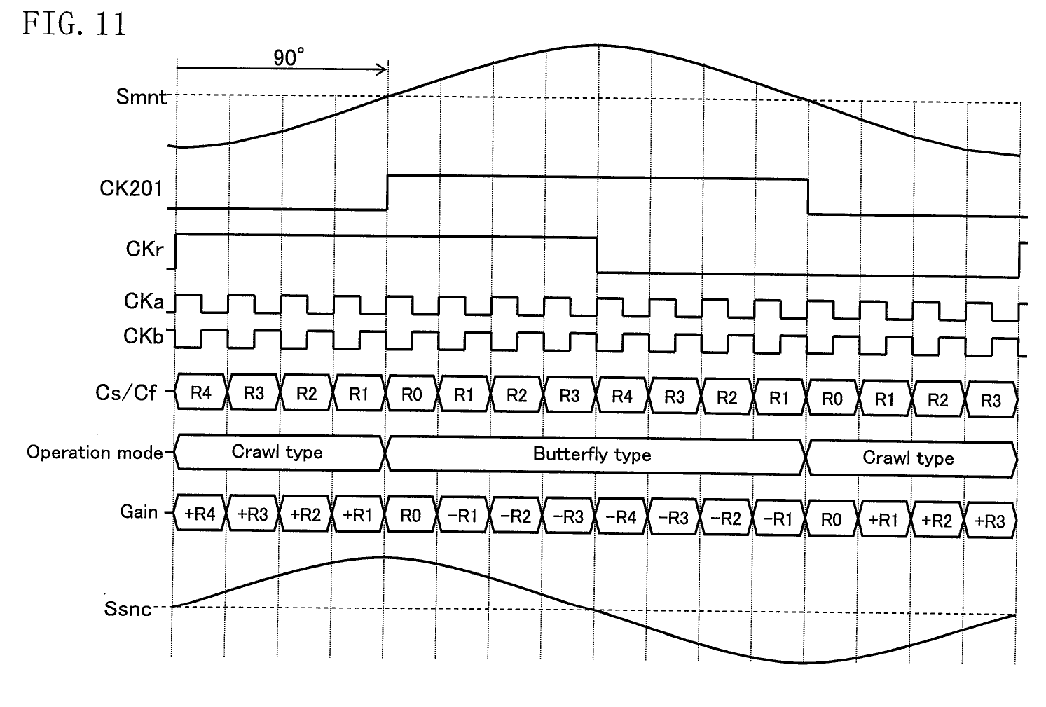

As shown in FIG. 11, under the principle of generation of Coriolis force, the phase of the monitor signal Smnt is 90° behind the phase of the sensor signal Ssnc. The phase adjustment circuit 202 delays the reference clock CK201 by 270° and outputs the delayed clock as the reference clock CKr. With this, the phase of the reference clock CKr matches with the phase of the sensor signal Ssnc. Thereafter, in the detection circuit 11, the control circuit 102 changes the capacitance ratio (Cs/Cf) and the drive mode of the switched capacitor 101 so that the time change in the gain of the switched capacitor 101 can be approximated to the waveform of a detection signal for detecting the physical quantity signal (waveform of the cosine wave signal synchronizing with the sensor signal Ssnc). As a result, the sensor signal Ssnc is virtually multiplied by the cosine wave signal, and the multiplication result is outputted as the detection output signal S101.

As described above, by approximating the time change in the gain of the switched capacitor 101 to a cosine waveform, noise superimposed on the detection output signal S101 can be reduced, and hence the physical quantity signal superimposed on the sensor signal Ssnc can be detected accurately.

The phase adjustment circuit 202 may be omitted, and the control circuit 102, receiving the reference clock CK201, may set the timing of change of the capacitance ratio and the timing of change of the drive mode considering the phase difference between the reference clock CK201 and the sensor signal Ssnc. With this setting, also, the detection signal expressed by the time change in the gain of the switched capacitor 101 can be synchronized with the sensor signal Ssnc. Also, the frequency of the multiplied clock for defining the timing of change of the capacitance ratio (Cs/Cf) is preferably at least four times as high as that of the drive signal Sdrv (or the monitor signal Smnt).

As described above, the detection circuit described above, which can reduce noise superimposed on the detection output signal, is suitable for signal processing systems such as reception systems and sensor systems.

It should be noted that the embodiments described above are essentially preferred illustrations, and by no means intended to restrict the scope of the present invention, applications thereof, or uses thereof.

What is claimed is:

1. A detection circuit configured to detect a desired signal from an input signal, comprising:
a switched capacitor having a differential amplifier and a sampling capacitance and a feedback capacitance at least one of which has a variable capacitance value, the switched capacitor being switchable between a first drive mode of amplifying the input signal with a positive gain responsive to a capacitance ratio of the sampling capacitance to the feedback capacitance and a second drive mode of amplifying the input signal with a negative gain responsive to the capacitance ratio; and
a control circuit configured to change the capacitance ratio, and also change the drive mode of the switched capacitor, at predetermined timing.

2. The detection circuit of claim 1, wherein the control circuit changes the capacitance ratio, and also changes the drive mode of the switched capacitor, so that a time change in the gain of the switched capacitor can be approximated to the waveform of a detection signal for detecting the desired signal.

3. The detection circuit of claim 2, wherein the detection signal is a trigonometric function wave signal synchronizing with the input signal.

4. The detection circuit of claim 1, wherein at least one of the sampling capacitance and the feedback capacitance includes:
n (n is an integer equal to or more than 2) capacitances each being switchable between a valid state where the capacitance is used as the sampling capacitance or the feedback capacitance and an invalid state where the capacitance is not used as the sampling capacitance or the feedback capacitance, the n capacitances having capacitance values different from each other; and
a capacitance setting section configured to set one capacitance or a plurality of capacitances, among the n capacitances, to the valid state so that the total of the capacitance value or values of the capacitance or capacitances in the valid state, among the n capacitances, should be a value corresponding to the control by the control circuit.

5. The detection circuit of claim 1, wherein the input signal is a sensor signal outputted from a physical quantity sensor configured to detect a physical quantity given externally, and
the desired signal is a physical quantity signal corresponding to the physical quantity.

6. The detection circuit of claim 5, wherein the control circuit changes the capacitance ratio, and also changes the drive mode of the switched capacitor, so that a time change in the gain of the switched capacitor can be approximated to the waveform of a cosine wave signal synchronizing with the sensor signal.

7. A physical quantity sensor device comprising:
a physical quantity sensor configured to vibrate from self-excitation by application of a drive signal to output a monitor signal responsive to the self-excited vibration, and also output a sensor signal according to a physical quantity given externally;
a drive circuit configured to control the drive signal based on the monitor signal; and
the detection circuit of claim 5.
